(19) United States
(12) Patent Application Publication
(10) Pub. No.: US 2005/0046706 A1
(43) Pub. Date: Mar. 3, 2005

(54) Image data capture method and apparatus

(76) Inventors: Robert Sesek, Meridian, ID (US); Curtis Reese, Boise, ID (US); Brett A. Green, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/650,219

(22) Filed: Aug. 28, 2003

(51) Int. Cl. H04N 5/76

(52) U.S. Cl. 348/231.3

(57) ABSTRACT

A camera that records the location of the object of a picture includes a module that determines the position of the object of a picture using GPS, range, and angle. A method of associating the calculated coordinates of the object of the photograph with a textual description of the object of the photograph includes retrieving textual information based on the coordinates of the object of the image from a database or online service providing such information.

### FIELD

The present invention relates generally to photography and in particular the present invention relates to cameras and images.

### BACKGROUND

Cameras and especially digital cameras have become commonplace in modern society. The technology of capturing digital images has advanced rapidly. Traditional non-digital cameras (such as but not limited to reflex cameras, instant cameras, video cameras, and the like) already are capable of recording information about images including for example the time and date of image capture. Also, digital cameras record much information about each image, including for example time and date, shutter speed, aperture, camera MAC address, and the like. Such information will be referred to herein as meta-data. Meta-data can be stored with the image itself, or separate from the image and associated with the image.

Cameras, including both traditional cameras and digital cameras, that determine the position of the camera when taking a picture are known. Typically, such cameras contain a global positioning system (GPS) device that can determine the position of the camera when a picture is taken, using satellites and a GPS receiver in known fashion. However, such cameras have a number of shortcomings. Those shortcomings include, for example, the general problem of the camera recording information on the location of the camera when the picture is being taken. In many instances, and especially in outdoor and scenic photography, the position of the camera is not as important as the position of the object of the image the camera records. That is, when a photographer takes a picture of an object, the cameras presently available that record position information record the position of the camera. In some instances, the object being photographed can be many miles from the position of the camera.

Further disadvantages with cameras that record position information of the camera when taking pictures are that the position data typically does not mean much to a viewer of a photograph. Global positioning systems are the most common type of position recording instrument used in cameras that record position of the camera when a picture is taken. However, for most users and for most viewers of photographs, the latitude and longitude of the camera when a picture is taken are not meaningful. It is extremely difficult for picture viewers to associate the camera's latitude and longitude with a specific object or location.

For the reasons stated above, and for other reasons stated below which will become apparent to those skilled in the art upon reading and understanding the present specification, there is a need in the art for an improved position recording system as well as for a system that more clearly identifies the position of a camera or image upon taking a picture with the camera.

### SUMMARY

The above-mentioned problems of difficult to understand location and coordinate data, recording only the position of a camera, and other problems are addressed by the present invention and will be understood by reading and studying the following specification.

In one embodiment, a method of capturing photographic image information includes providing a camera with a global positioning system receiver, capturing an image with the camera, determining a position of an object of the captured image, and storing data indicative of the position of the object of the captured image with the image.

In another embodiment, a method of associating textual information about an object in a photograph includes obtaining captured coordinates of the object from the captured data for the image, comparing the coordinates to a database of known coordinates, retrieving appropriate textual data, and embedding with the captured data the retrieved textual information about objects having known coordinates corresponding to the captured coordinates.

In yet another embodiment, a camera includes a processor, an image data capture module connected to the processor, the image data capture module to capture image data corresponding to a position of an object of a photograph taken by the camera, and a storage element connected to the processor for storing images and captured image data.

In still another embodiment, a camera includes a processor, a storage element connected to the processor for storing images and image information, and means for storing image data corresponding to a position of an object of a photograph taken by the camera.

In another embodiment, an image data capture module includes a global positioning system to record coordinates of a camera when a photograph is taken, a range finder to record a range to an object of the photograph when the photograph is taken, and a compass to record a magnetic bearing of the object of the photograph when the photograph is taken.

Other embodiments are described and claimed.

### BRIEF DESCRIPTION OF DRAWINGS

FIG. 1 is a block diagram of a camera according to one embodiment of the present invention;

FIG. 2 is a block diagram of an image data capture module according to another embodiment of the present invention;

FIG. 3 is a flow chart diagram of a method according to another embodiment of the present invention;

FIG. 4 is a flow chart diagram of a method according to yet another embodiment of the present invention;

FIG. 5 is a flow chart diagram of a method according to still another embodiment of the present invention;

FIG. 6 is an elevation view of a photograph being taken using embodiments of the present invention; and

FIG. 7 is a top view of the photograph taking of FIG. 6.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

The following detailed description is, therefore, not to be taken in a limiting sense, and the scope of the present invention is defined only by the appended claims, along with the full scope of equivalents to which such claims are entitled.

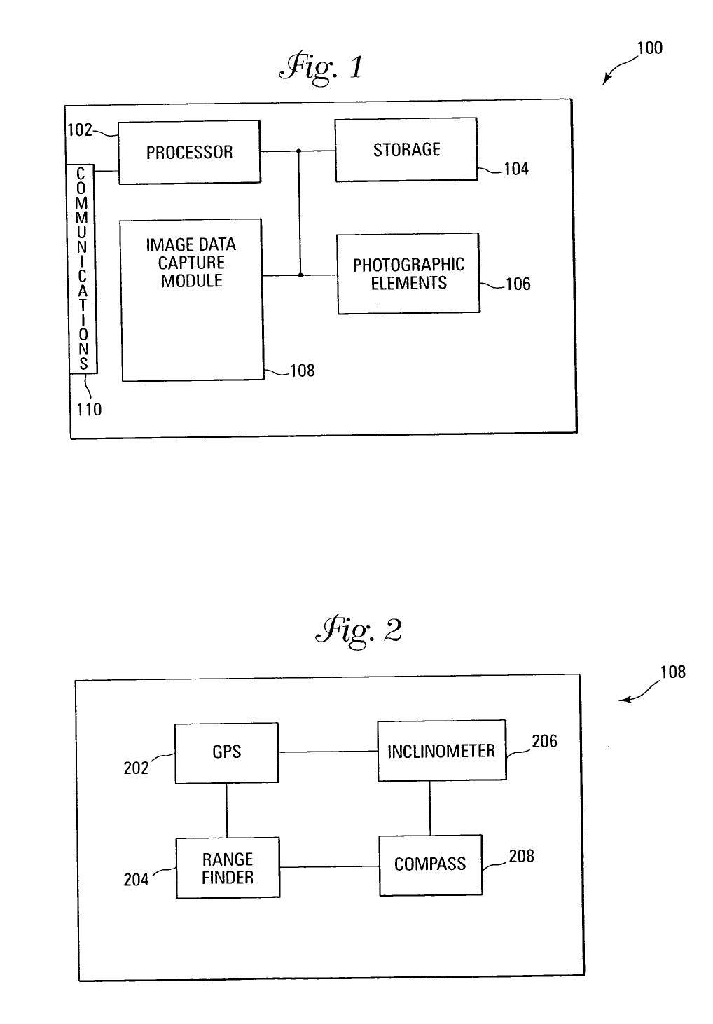

FIG. 1 is a block diagram of a camera 100 that takes pictures and identifies each picture with image data. Camera 100 comprises a central processing unit (CPU) 102 that controls operation of the camera 100, storage 104 for storing images and/or image data, photographic elements 106 for exposing and recording images, image data capture module 108, and communications system 110. In a digital camera, image data and meta-data is stored in storage 104, typically for later download to another medium, such as a computer hard disk or the like, through communications system 110. Communications system 10 may include by way of example only and not by way of limitation, serial ports, universal serial bus (USB) ports, parallel ports, firewire ports, infrared (IR) ports, and the like. Images and image data are transferred to an external device via protocols which are known in the art.

The image data of and for the pictures includes in one embodiment time and date, shutter speed, aperture, camera MAC address, camera position data, and image position data gathered by image data capture module 108. The data is stored in storage 104, and is associated with the image to which it corresponds.

A more detailed description of image data capture module 108 according to another embodiment of the present invention is shown in greater detail in FIG. 2. Image data capture module 108 comprises in one embodiment a global positioning system (GPS) 202, a rangefinder 204, an inclinometer 206, and a compass 208. When a user takes a picture using a camera, such as camera 100, that includes image data capture module 108, at the time of the picture being taken, the image data capture module records at least the position of the camera, the range to the object of the picture, the inclination of the camera, and the angle with respect to north (magnetic bearing with respect to north) for the direction the camera lens is pointed. With this information, the location of the object of the image is computed, either by the processor or by a separate calculation made later. With the information including camera position, range to the object of the photograph, the inclination of the camera, and the angle with respect to north of the camera lens, the actual coordinates of the object of the photograph is determined. This information, in either or both of raw and converted data, is transferred to storage such as storage 104 for later downloading.

In another embodiment, the range finding function of rangefinder 204 is provided by components of the camera itself. Autofocus cameras typically use an infrared beam that is emitted from the camera to assist in focusing the lens of the camera. This infrared autofocus is used in one embodiment to provide the range from the camera to the object of an image that is being photographed.

Using the obtained position of the camera from the GPS device in the camera, and using inclination of the camera, a compass heading of the camera, and the range from the camera to the object of the image, it is simply a matter of mathematics to determine the position of the object of the photograph. For example, a photographer might be many miles from the object of a photographic image. The rangefinder determines the range to the object of the photograph to be taken. This range, along with the other parameters gathered is then used to calculate the coordinates of the object of the image.

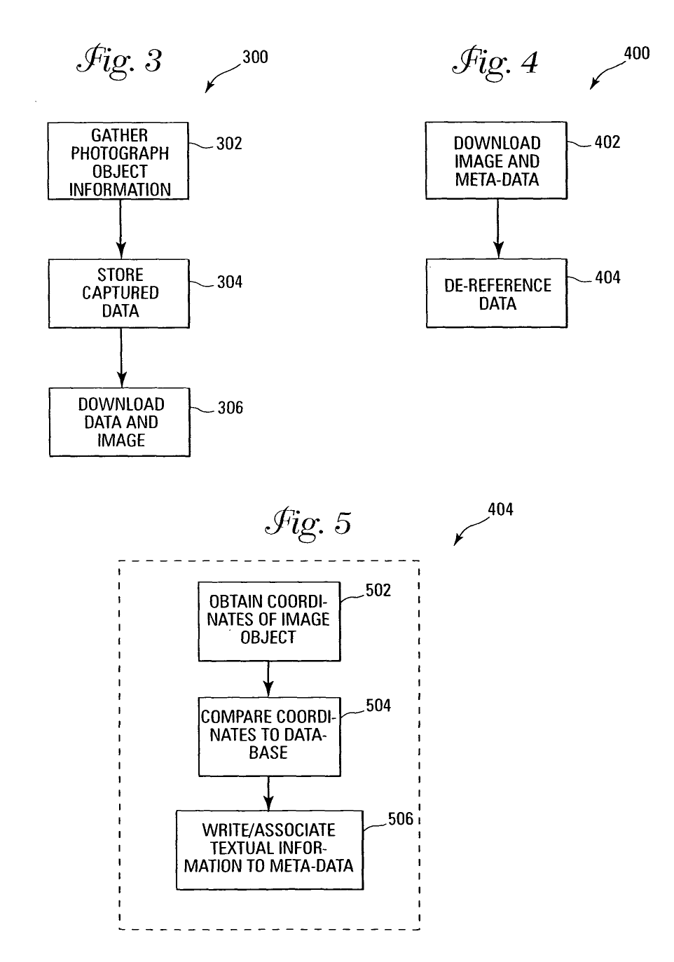

With the image location data from the image data capture module 108, the embodiments of the present invention allow for the automatic identification of the object of the image of a photograph through the use of one or more electronic databases of locations of various objects, some to a great degree of accuracy. For example, a photographer is taking pictures in a national park. The actual locations of certain objects within such a park are known and present in an electronic database. When the photographer takes a photograph of an object, the embodiments of the present invention function as follows, with reference to method 300 of FIG. 3. When a photographer takes a photograph, the image data capture module gathers photograph object information in block 302, and stores the captured data in storage in block 304. In one embodiment, the captured data is also converted to image object location data before storage in memory. Once the data is stored in memory, along with any other meta-data that is desired to be stored, the image and its corresponding data are available for download to another medium as described above. The data and image are downloaded in block 306.

Once the image and data are downloaded, the positional coordinates for the object of each image are available. This data is still in the form of either raw data or converted data as described above, and as such, it comprises primarily coordinates, and is typically stored in the form of latitude and longitude data. This latitude and longitude data may be helpful to one familiar with a particular area or location, but for those unfamiliar with latitude and longitude data, the embodiments of the present invention provide the conversion of that data to a textual description of the location of the object of the image.

FIG. 4 is a flow chart diagram of a method 400 for automatically translating raw image data as has been described above into understandable textual descriptions of the object of an image. Method 400 comprises downloading image meta-data comprising at least latitude and longitude coordinate data for an image captured by a camera in block 402, and de-referencing the data in block 404.

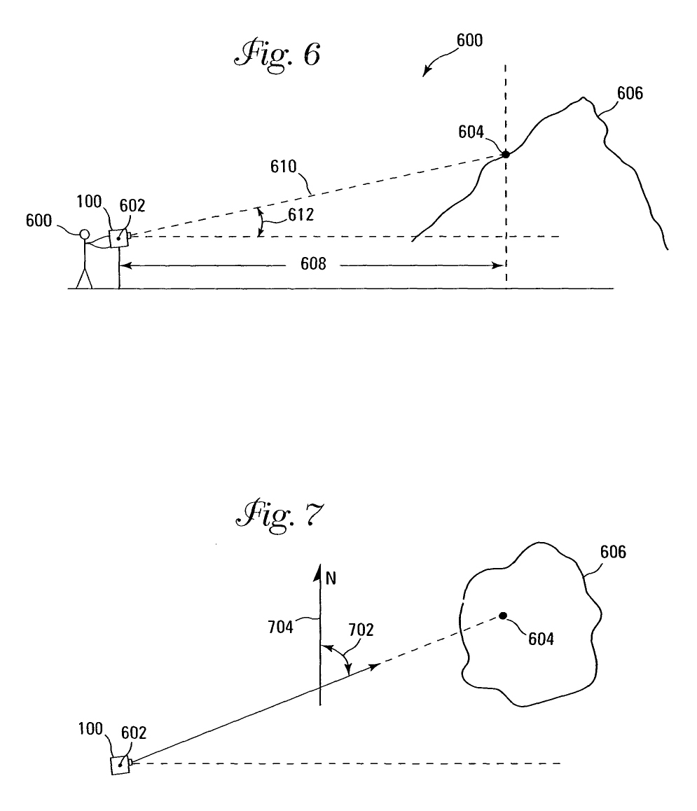

De-referencing the data is shown in greater detail in FIG. 5, and comprises obtaining the coordinates for the object of the image in block 502, and comparing the coordinates to a database of known coordinates in block 504. When a match is found, textual information about the object of the image is written to the meta-data or stored in association with the meta-data and the image automatically in block 506. For example, a photographer takes a photograph of a mountain in the distance from where the photographer is located. The camera records the position of the camera from the GPS in the camera. The camera further records the distance to the object focused in the camera lens, records the inclination of the camera, and records a magnetic bearing of the lens.

In operation, the camera and method embodiments of the present invention function as follows. Explanation is made with reference to FIGS. 6 and 7, which show an example of the taking of a photograph. In FIG. 6, photographer 600 has a camera, such as camera 100 equipped with an image data capture module as described above. Photographer 600 is focusing camera 100 at point of focus 604 of object 606. The GPS or other position determining device in camera 100 determines camera location 602, which may include elevation as well as latitude and longitude. The range finder of camera 100 determines the range 608 to the focus point, in various embodiments on a substantially horizontal plane from the camera location 602, or along the line of sight 610 from the camera location 602 to the point of focus 604. The inclinometer determines the inclination angle 612. In one embodiment, the inclination angle is used to adjust the range finder data such that the camera's position is taken into account. Referring also to FIG. 7, which is a view of FIG. 6 from a top perspective, the compass in the camera 100 determines a magnetic bearing angle 702 with respect to north (indicated by arrow 704).

The basics of camera function and operation are well known for both film and digital cameras. As such, it should be understood that those skilled in the art will appreciate that the herein-described camera has been simplified to provide a basic understanding of camera technology and is not intended to describe all of the features of a camera.

It should be further understood that while a digital camera has been disclosed and discussed, the embodiments of the present invention are suitable for use with any camera equipped therewith. For example, the embodiments of the present invention are amenable to use with cameras such as digital cameras, reflex cameras, disposable cameras, view cameras, video cameras, camcorders, and the like.

Conclusion

Cameras and methods have been described that include an image data capture module and apparatus. The embodiments of the present invention capture the location of an object of an image, and capture camera details to allow reproduction of the image at a later date. The coordinates of the location of the object of the image are used to look up textual descriptions of the objects of the image and associate them with the image.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of capturing photographic image information, comprising:
providing a camera with a global positioning system receiver;
capturing an image with the camera;
determining a position of an object of the captured image; and
storing data indicative of the position of the object of the captured image with the image.

2. The method of claim 1, wherein the image is digital.

3. The method of claim 1, wherein determining a position of the captured image comprises:
obtaining global position coordinates of the camera;
obtaining a range from the camera to the object;
obtaining a magnetic bearing of the object; and
calculating the position of the object of the captured image by translating the range and magnetic bearing from the global position coordinates to provide coordinates of the object.

4. The method of claim 3, and further comprising:
associating captured data with a physical description of the subject of the captured image.

5. The method of claim 4, wherein associating captured data with a physical description of the subject of the captured image comprises:
comparing the coordinates of the object of the photograph to a set of known coordinates; and
embedding with the captured data textual information about objects having known coordinates corresponding to the coordinates of the object.

6. The method of claim 5, wherein embedding further comprises retrieving textual information about the object at the known coordinates.

7. The method of claim 1, and further comprising:
associating captured data with a physical description of the subject of the captured image.

8. The method of claim 7, wherein associating captured data with a physical description of the subject of the captured image comprises:
comparing the coordinates of the object of the photograph to a set of known coordinates; and
embedding with the captured data textual information about objects having known coordinates corresponding to the coordinates of the object.

9. A method of capturing photographic image information, comprising:
providing a camera with a global positioning system receiver;
capturing an image with the camera;
obtaining global position coordinates of the camera;
obtaining a range from the camera to the object;
obtaining a magnetic bearing of the object;
calculating the position of the object of the captured image by translating the range and magnetic bearing from the global position coordinates to provide coordinates of the object;
storing data indicative of the position of the object of the captured image with the image; and
associating captured data with a physical description of the subject of the captured image.

10. A method of associating textual information about an object in a photograph, comprising:
obtaining captured coordinates of the object from the captured data for the image;
comparing the coordinates to a database of known coordinates;
retrieving appropriate textual data to the captured coordinates; and
embedding with the captured data the retrieved textual information about objects having known coordinates corresponding to the captured coordinates.

11. The method of claim 10, wherein obtaining captured coordinates of the object comprises:
downloading captured data for an image from a camera that took the image.

12. A camera, comprising:
a processor;
an image data capture module connected to the processor, the image data capture module to capture image data corresponding to a position of an object of a photograph taken by the camera; and
a storage element connected to the processor for storing images and captured image data.

13. The camera of claim 12, wherein the image data capture module comprises:
a global positioning system to record coordinates of the camera when a photograph is taken;
a range finder to record a range to the object of the photograph when the photograph is taken; and
a compass to record a magnetic bearing of the object of the photograph when the photograph is taken.

14. The camera of claim 13, wherein the image data capture module further comprises:
an inclinometer to record an inclination with respect to level of the camera when a photograph is taken.

15. A camera, comprising:
a processor;
an image data capture module connected to the processor, the image data capture module to capture image data corresponding to a position of an object of a photograph taken by the camera, the image data capture module comprising:
a global positioning system to record coordinates of the camera when a photograph is taken;
a range finder to record a range to the object of the photograph when the photograph is taken; and
a compass to record a magnetic bearing of the object of the photograph when the photograph is taken; and
a storage element connected to the processor for storing images and captured image data.

16. A camera, comprising:
a processor;
a storage element connected to the processor for storing images and image information; and
means for storing image data corresponding to a position of an object of a photograph taken by the camera.

17. An image data capture module, comprising:
a global positioning system to record coordinates of a camera when a photograph is taken;
a range finder to record a range to an object of the photograph when the photograph is taken; and
a compass to record a magnetic bearing of the object of the photograph when the photograph is taken.

18. The image data capture module of claim 17, and further comprising:
an inclinometer to record an inclination with respect to level of the camera when a photograph is taken.

19. An image data capture module, comprising:
a global positioning system to record coordinates of a camera when a photograph is taken;
a range finder to record a range to an object of the photograph when the photograph is taken;
a compass to record a magnetic bearing of the object of the photograph when the photograph is taken; and
an inclinometer to record an inclination with respect to level of the camera when a photograph is taken.

20. An image data capture module for a camera with a global positioning system, the image data capture module comprising:
a range finder to record a range to an object of a photograph when the photograph is taken; and
a compass to record a magnetic bearing of the object of the photograph when the photograph is taken.

21. The image data capture module of claim 20, and further comprising:
an inclinometer to record an inclination with respect to level of the camera when a photograph is taken.
